(19) United States
(12) Patent Application Publication
(10) Pub. No.: US 2025/0242879 A1
(43) Pub. Date: Jul. 31, 2025

(54) APPARATUS FOR MOTORCYCLE FAIRING COVER

(71) Applicant: Stephen M. Faherty, Marlborough, MA (US)

(72) Inventor: Stephen M. Faherty, Marlborough, MA (US)

(21) Appl. No.: 18/896,379

(22) Filed: Sep. 25, 2024

Related U.S. Application Data
(63) Continuation-in-part of application No. 18/425,090, filed on Jan. 29, 2024, now abandoned.

(51) Int. Cl. B62J 23/00; B62J 17/02

(52) U.S. Cl. CPC B62J 23/00; B62J 17/02

(57) ABSTRACT

Apparatus are provided for motorcycle fairing covers. The apparatus presented comprises a body, one or more straps or openings or mechanisms to reversibly secure the apparatus to the motorcycle, and components to adjust the fit of the cover to the motorcycle. The apparatus may be elastic such that a single model may fit a range of motorcycles. The apparatus can be affixed to and removed from a motorcycle without the need to adjust, remove, or replace any components of or fasteners on the motorcycle. A user may use the apparatus to protect the fairing of the motorcycle, and to decorate the motorcycle as desired by the user. The apparatus solves problems with the currently available apparatuses of the prior art of ease and speed of use, of customization, and of completeness of coverage and protection of the fairing.

### CROSS-REFERENCE TO RELATED APPLICATIONS

This application is a continuation-in-part of U.S. patent application Ser. No. 18/425,090, filed on Jan. 29, 2024, entitled “APPARATUS FOR MOTORCYCLE FAIRING COVER,” which is incorporated herein by reference in its entirety.

### FIELD OF THE INVENTION

The presently disclosed subject matter relates to apparatus for motorcycle fairing covers, and more particularly, to apparatus for providing motorcycle fairing covers that cover all or approximately all of the front of the motorcycle's fairing, are simple to attach and detach, do not damage the fairing, do not require removing or replacing parts of the motorcycle, and are customizable in appearance.

### BACKGROUND OF THE INVENTION

The front fairing of motorcycles serves to deflect wind and debris, protecting the rider and the rest of the motorcycle. Accordingly, the fairing is often hit by debris and damaged, dinged, or scratched. Additionally, the fairing may be painted or decorated, but such painting is difficult and costly, as with any automotive painting. A fairing cover may serve both to protect the fairing from damage, and to decorate the fairing area in a way that is easily reversed or changed. Prior art devices exist for fairing covers, such as U.S. Pat. No. 9,211,929, to Holeman and Holeman, for a “Protective Cover For Motorcycle Fairing”. Shortcomings of prior art devices include the need to add or replace buttons, anchors, bolts, or machine screws into braze-ons (that is, a fitting that is welded, glued, riveted, formed as part of, or molded onto or into the larger frame or other components of the motorcycle), or other attachment points built as part of the motorcycle fairing, the windshield attachment, or other attachment points on or in the motorcycle, generally in the vicinity of the fairing. Such methods of attachment and removal of prior art fairing covers have the drawback of requiring a relatively time-consuming process for attachment or removal of the prior art fairing covers. Furthermore, such prior art fairing covers carry the risk of losing the parts, such as bolts, that were original to the motorcycle, or of damaging the threading or other mounting means of the receptacle or attachment components of the motorcycle.

The prior art also does not function well at completely covering the fairing. Because the prior art devices must be sized to fit the hard attachment points built into or on the motorcycle, the prior art fairing covers do not cover the fairing completely. This leads to two disadvantages. First, the prior art fairing covers cannot offer protection of the entire fairing. Second, the prior art fairing covers cannot serve to show a design or decoration of the rider's choice completely, because they don't cover the entire fairing, such that some of the original fairing will still be visible alongside the rider's desired design or color scheme on the fairing covers.

### SUMMARY OF THE INVENTION

The present invention meets all these needs, by disclosing apparatus for motorcycle fairing covers that cover an entire front of, or approximately the entire front of, a motorcycle fairing, which may be quickly and simply attached and detached without adding, replacing, or removing any parts or connectors from the motorcycle, and which may show a design or decoration and cover the entirety of the motorcycle fairing.

The present invention addresses the problems of the prior art, which do not present apparatus for motorcycle fairing covers which cover the entire fairing, and which may be quickly and simply attached and detached, and which allow for a design or decoration and cover the entirety of the motorcycle fairing. Furthermore, unlike some motorcycle fairing covers which cover the rear of the fairing and are intended for protection of the gauges and equipment from sun or rain while parked but which must be removed to operate the motorcycle, the present disclosure may be used on a motorcycle while the user is riding it, making the present disclosure convenient and easy to use and leave on the motorcycle for protection of the front of the fairing.

The present disclosure is advantageously for a “batwing” style motorcycle fairing, as are often found on Harley Davidson™ motorcycles and other motorcycles with similar styles of fairings. Such a fairing is typically attached to the front forks of the motorcycle and to the handlebar assembly, and moves side to side when the user turns the handlebars. As will be apparent to one of skill in the art, the fairing cover of the present disclosure will also turn with such a fairing, and in some aspects of the present disclosure, the apparatus may be used with other styles or arrangements of motorcycle fairings.

In one aspect, the present disclosure comprises an apparatus for a motorcycle fairing cover, the apparatus comprising: a cover body, which cover body comprises a body material and a perimeter cord, and wherein the perimeter cord extends around an outer perimeter of the cover body; and wherein the perimeter cord is affixed to the cover body at a location on the cover body referred to as a first-cord-end-location, at a first perimeter cord end of the perimeter cord, and wherein the perimeter cord is affixed to the cover body at a location on the cover body referred to as a second-cord-end-location, at a second perimeter cord end of the perimeter cord; and wherein the perimeter cord is further retained to the cover body with a plurality of cord-retention-units, in a vicinity of the outer perimeter.

In one aspect, the apparatus for a motorcycle fairing cover comprises wherein the first perimeter cord end and the second perimeter cord end are affixed to the cover body at locations approximately near a top of the cover body.

In one aspect, the apparatus for a motorcycle fairing cover comprises wherein the first perimeter cord end and the second perimeter cord end are affixed to the cover body at locations approximately near where the corners of a windshield of a motorcycle meet the motorcycle fairing cover of the motorcycle.

In one aspect, the apparatus for a motorcycle fairing cover comprises wherein the perimeter cord may be secured with a perimeter cord lock.

In one aspect, the apparatus for a motorcycle fairing cover comprises wherein the plurality of cord-retention-units are affixed to the outer perimeter of the cover body, and wherein the plurality of cord-retention-units are distributed around the outer perimeter of the cover body.

In one aspect, the apparatus for a motorcycle fairing cover comprises wherein the plurality of cord-retention-units are affixed approximately near the outer perimeter of the cover body, and wherein the plurality of cord-retention-units are distributed around the outer perimeter of the cover body.

In one aspect, the apparatus for a motorcycle fairing cover comprises wherein the plurality of cord-retention-units are each a single strap having two ends, sewn at both ends of each of the plurality of cord-retention-units to the cover body.

In one aspect, the apparatus for a motorcycle fairing cover comprises wherein the plurality of cord-retention-units are each two straps, affixing to the other of each matching pair of said straps by a cord-retention-unit-closure, wherein each of the plurality of cord-retention-units comprise a cord-retention-unit-closure.

In one aspect, the apparatus for a motorcycle fairing cover comprises wherein the perimeter cord crosses under a windshield of a motorcycle when the apparatus is installed on the motorcycle, wherein the perimeter cord is directed from the first perimeter cord end at the first-cord-end-location, towards the second-cord-end-location, and past the second-cord-end-location, and wherein the perimeter cord is directed from the second perimeter cord end at the second-cord-end-location, towards the first-cord-end-location, and past the first-cord-end-location.

In one aspect, the apparatus for a motorcycle fairing cover comprises wherein the cover body comprises a headlight opening, wherein the headlight opening is not a hole in the cover body; and wherein the headlight opening comprises an enlarged slot opening in the cover body; and wherein the cover body further comprises a headlight closure element; wherein the headlight closure element comprises elements on both sides of the cover body adjacent the headlight opening.

In one aspect, the apparatus for a motorcycle fairing cover comprises wherein the headlight opening comprises an inner perimeter; and wherein there is disposed around at least a portion of the inner perimeter a material that is at least one of soft, elastic, and/or non-slip.

In one aspect, the apparatus for a motorcycle fairing cover comprises wherein the apparatus comprises no connection to the handlebars of a motorcycle.

These aspects of the present invention, and others disclosed in the Detailed Description of the Drawings, represent improvements on the current art. This summary is provided to introduce a selection of concepts in a simplified form that are further described below in the Detailed Description of the Drawings. This Summary is not intended to identify key features or essential features of the claimed subject matter, nor is it intended to be used to limit the scope of the claimed subject matter.

In embodiments of the subject invention, the terms “substantially” and “approximately” are defined as at least close to (and can include) a given value or state, as understood by a person of ordinary skill in the art. In one embodiment, the terms “substantially” and “approximately” refer to ranges within 10%, preferably within 5%, more preferably within 1%, and most preferably within 0.1% of the given value or state being specified. Where ranges are provided, the foregoing applies to both the start and end of the range of values given.

In embodiments of the subject invention, the term “relatively” is defined as a comparison of a property, or the proportion of a property between two components.

### BRIEF DESCRIPTION OF THE DRAWINGS

The foregoing summary, as well as the following detailed description of various aspects, is better understood when read in conjunction with the appended drawings. For the purposes of illustration, the drawings show exemplary aspects; but the presently disclosed subject matter is not limited to the specific methods and instrumentalities disclosed. In the drawings, like reference characters generally refer to the same components or steps of the device throughout the different figures. In the following detailed description, various aspects of the present invention are described with reference to the following drawings, in which:

FIG. 1 shows a front elevation view of an embodiment of the apparatus of the present disclosure.

FIG. 2 shows a rear elevation view of an embodiment of the apparatus of the present disclosure.

FIG. 3 shows a front elevation view of an embodiment of the apparatus of the present disclosure.

FIG. 4 shows a front elevation view of an embodiment of the apparatus of the present disclosure.

FIG. 5 shows a front elevation view of an embodiment of the apparatus of the present disclosure.

FIG. 6 shows a front elevation view of an embodiment of the apparatus of the present disclosure.

FIG. 7 shows a first side and front perspective view of an embodiment of the apparatus of the present disclosure.

FIG. 8 shows a second side and rear perspective view of an embodiment of the apparatus of the present disclosure.

FIG. 9 a second side and rear perspective view of an embodiment of the apparatus of the present disclosure.

FIG. 10 shows a front elevation view of an embodiment of the apparatus of the present disclosure on a motorcycle.

FIG. 11 shows a front elevation view of an embodiment of the apparatus of the present disclosure on a motorcycle.

FIG. 12 shows a front and top perspective view of an embodiment of the apparatus of the present disclosure on a motorcycle.

FIG. 13 shows a rear perspective view of an embodiment of the apparatus of the present disclosure on a motorcycle.

FIG. 14 shows a front elevation view of an embodiment of the apparatus of the present disclosure.

FIG. 15 shows a rear elevation view of an embodiment of the apparatus of the present disclosure.

FIG. 16 shows a rear elevation view of an embodiment of the apparatus of the present disclosure.

FIG. 17 shows a rear perspective view of an embodiment of the apparatus of the present disclosure on a motorcycle.

### DETAILED DESCRIPTION OF THE DRAWINGS

The presently disclosed invention is described with specificity to meet statutory requirements. But, the description itself is not intended to limit the scope of this patent. Rather, the claimed invention might also be configured in other ways, to include different steps or elements similar to the ones described in this document, in conjunction with other present or future technologies. Moreover, although the term “step” or similar terms may be used herein to connote different aspects of methods employed, the term should not be interpreted as implying any particular order among or between various steps herein disclosed unless and except when the order of individual steps is explicitly described.

In the following description, numerous specific details are set forth to provide a thorough understanding of the invention. But, the present invention may be practiced without these specific details. Structures and techniques that would be known to one of ordinary skill in the art have not been shown in detail, in order not to obscure the invention. Referring to the figures, it is possible to see the various major elements constituting the systems and apparatus of the present invention.

The present invention comprises an apparatus 100 for a motorcycle fairing cover, for use on a fairing 210 of a motorcycle 200 having a windshield 204, wherein the apparatus 100 covers all or approximately all of the fairing 210, and wherein the apparatus 100 may be quickly and simply attached to and detached from the fairing 210. Furthermore, the apparatus 100 allows for a design or decoration, referred to as a cover decoration 190, which may cover any portion or the entirety of the apparatus 100 covering the fairing 210. The cover decoration 190 may advantageously be designed or printed differently for different motorcycles, so that its appearance when the apparatus 100 is stretched over the fairing 210 does not appear distorted or stretched.

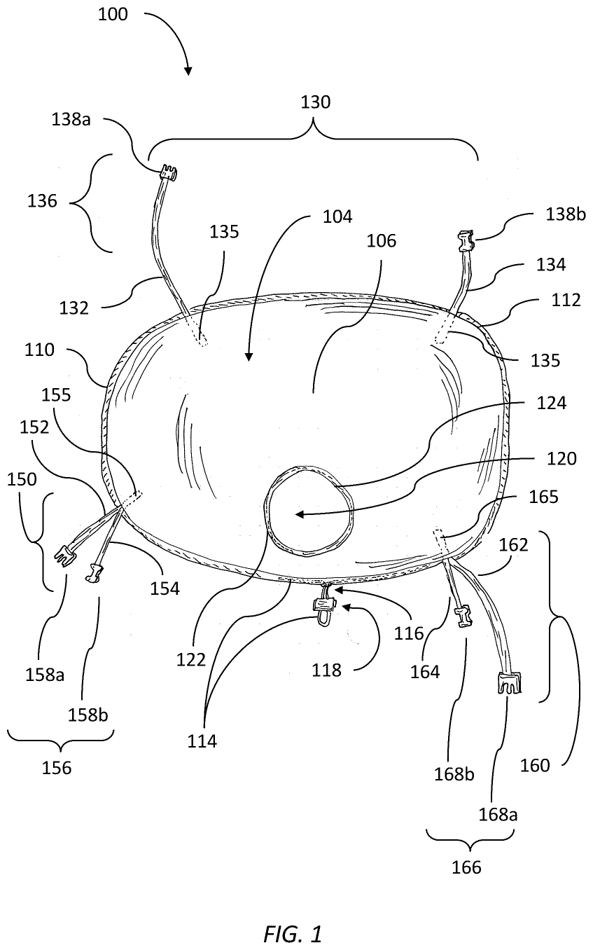

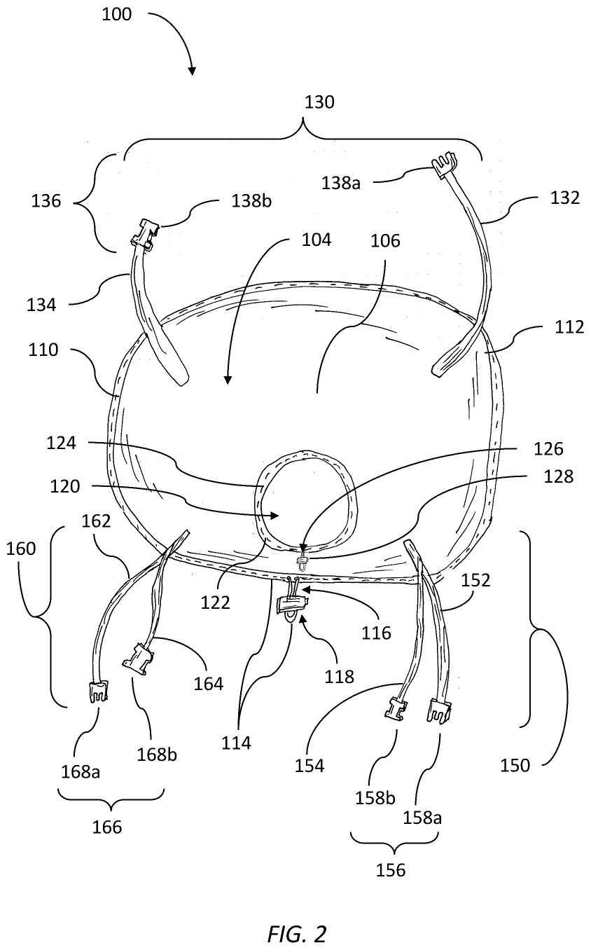

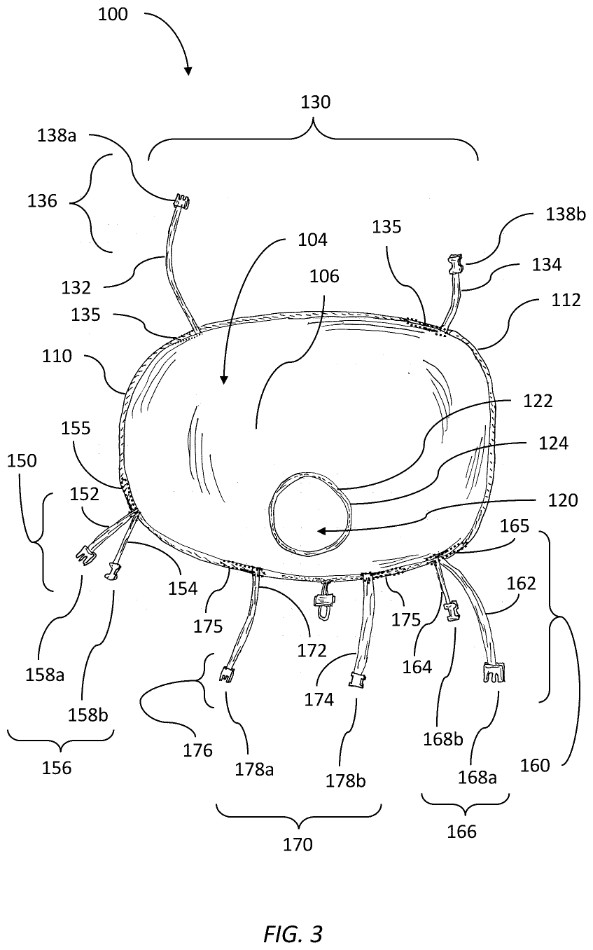

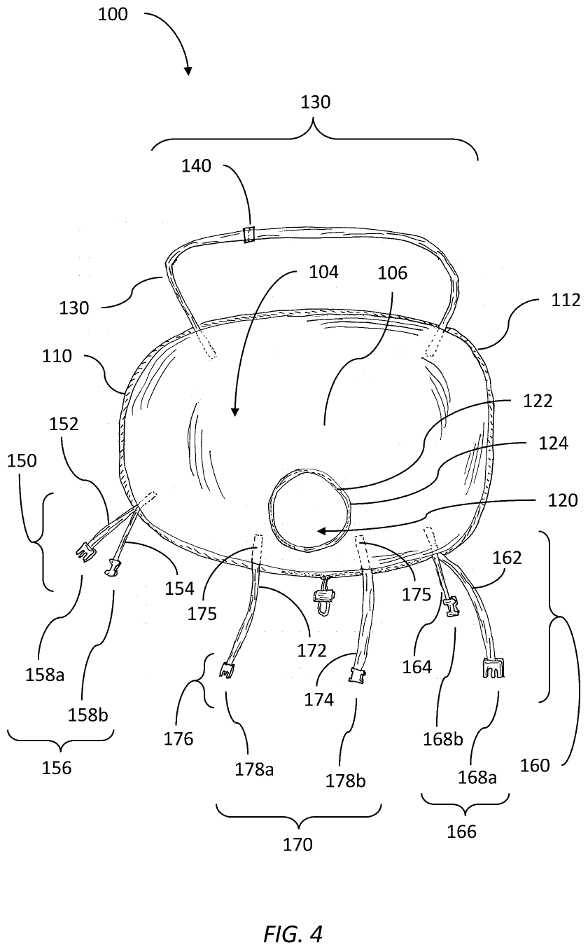

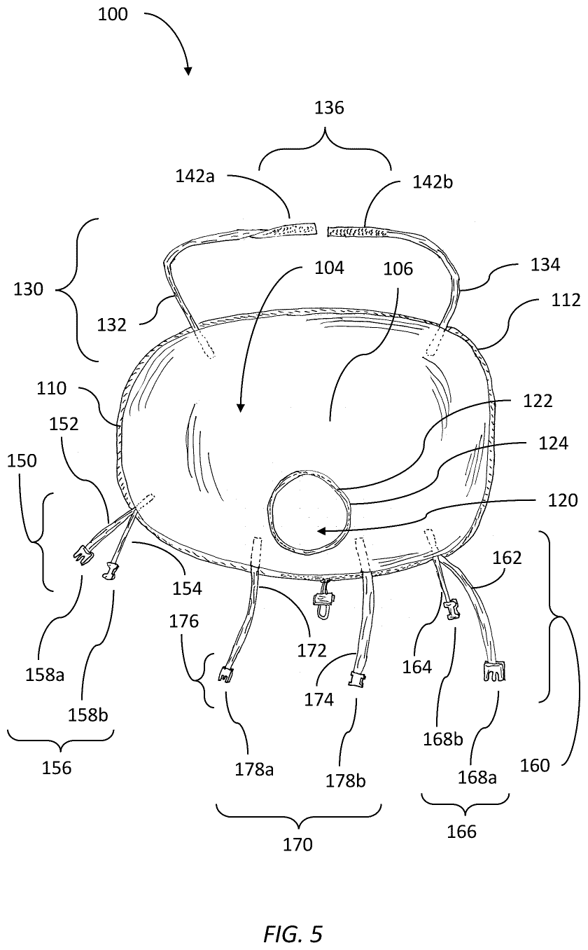

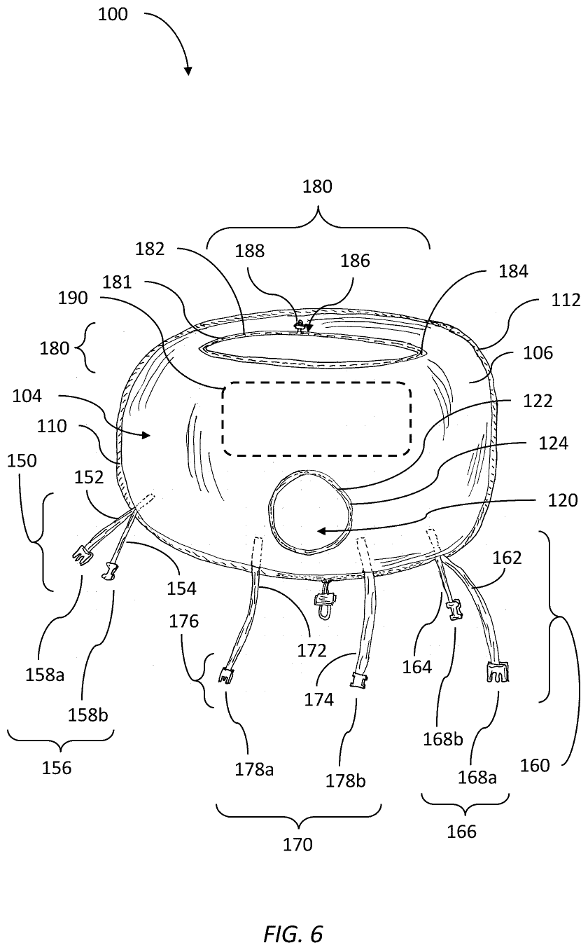

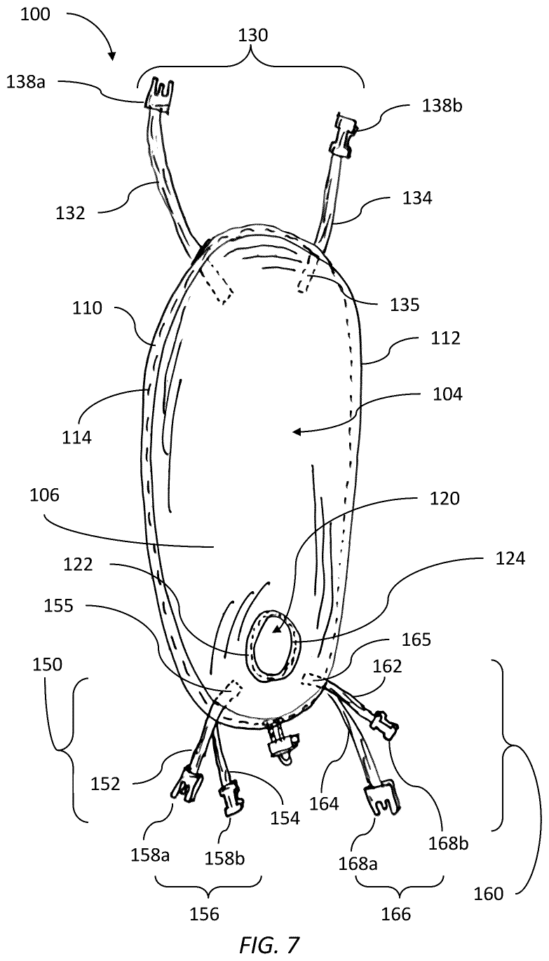

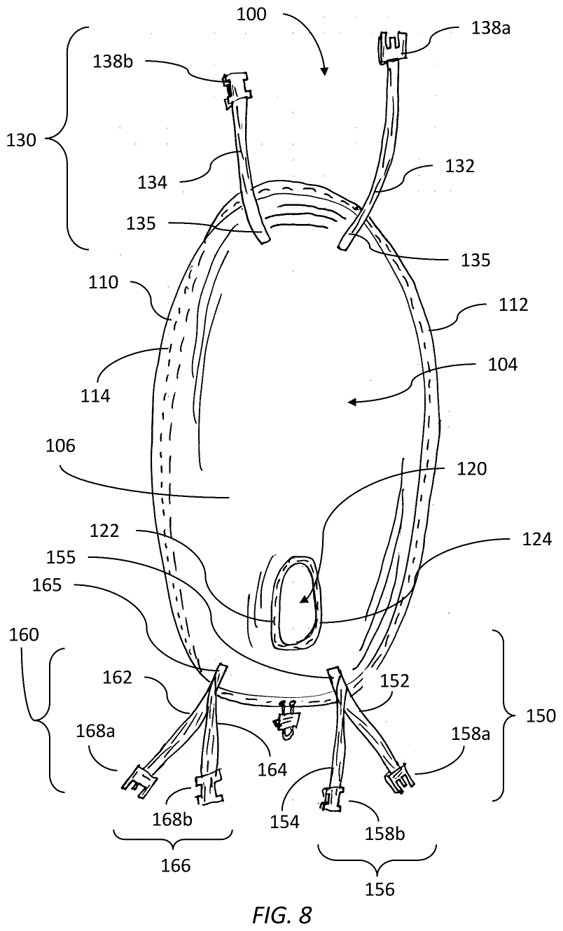

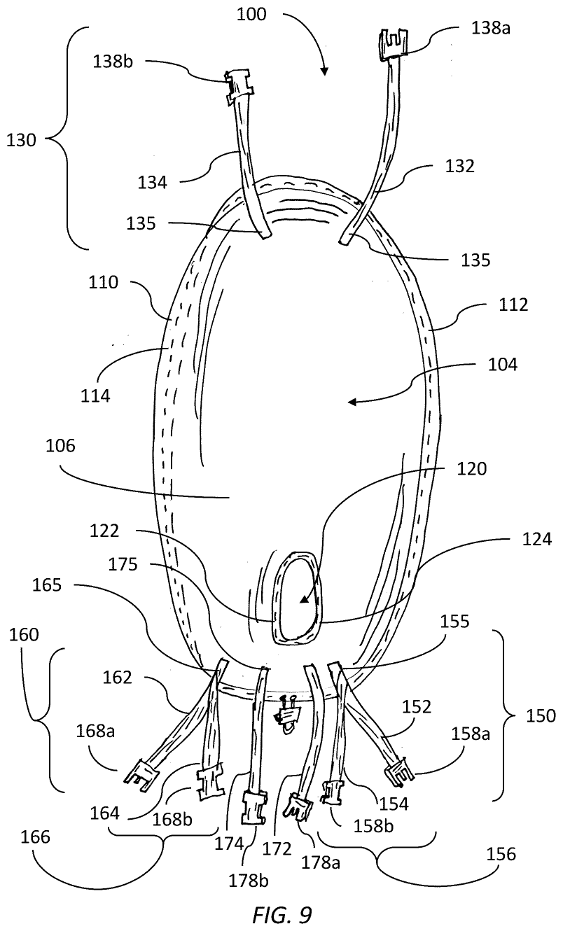

With reference to FIG. 1, FIG. 2, FIG. 3, FIG. 4, FIG. 5, FIG. 6, FIG. 7, FIG. 8, and FIG. 9, the apparatus 100 comprises a cover body 104, which cover body 104 comprises a body material 106, wherein the body material 106 may advantageously be a material or a mix of materials that can stretch, and advantageously are elastic. In some aspects of the present disclosure, the cover body 104 may comprise a single layer or sheet of the body material 106. In some aspects of the present disclosure, the cover body 104 may comprise multiple layers of the body material 106, and in some aspects of the present disclosure, the cover body 104 may comprise more than one type of material. In some aspects of the present disclosure, the cover body 104 further comprises a body perimeter channel 110, disposed around an outer perimeter 112 of the cover body 104. The body perimeter channel 110 is advantageously affixed shut by an amount of the body material 106, and encloses a channel disposed to contain a perimeter cord 114, and wherein the perimeter cord 114 extends around the outer perimeter 112 of the cover body 104. The body perimeter channel 110 comprises, advantageously, a perimeter opening 116, through which perimeter opening 116 the perimeter cord 114 extends, and wherein the perimeter cord 114 may be secured with a perimeter cord lock 118. The perimeter cord lock 118 may be used to adjust the tension in the perimeter cord 114, thus tightening the cover body 104. The perimeter cord 114 may be elastic, and may be sized and disposed to fit over the fairing 210 of a motorcycle 200, or over a range of the fairings of various motorcycles. In some aspects of the present disclosure, the perimeter cord 114 may be non-adjustable.

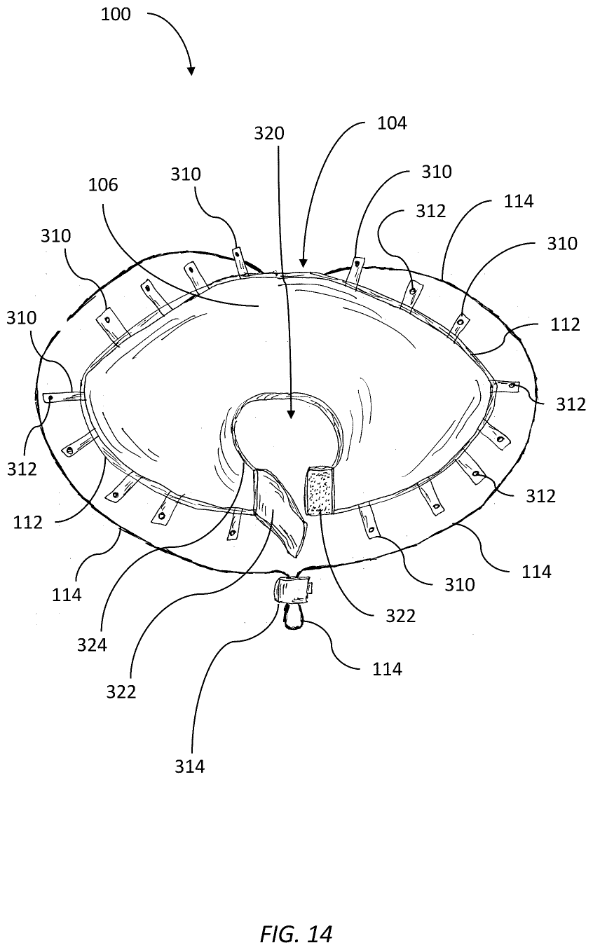

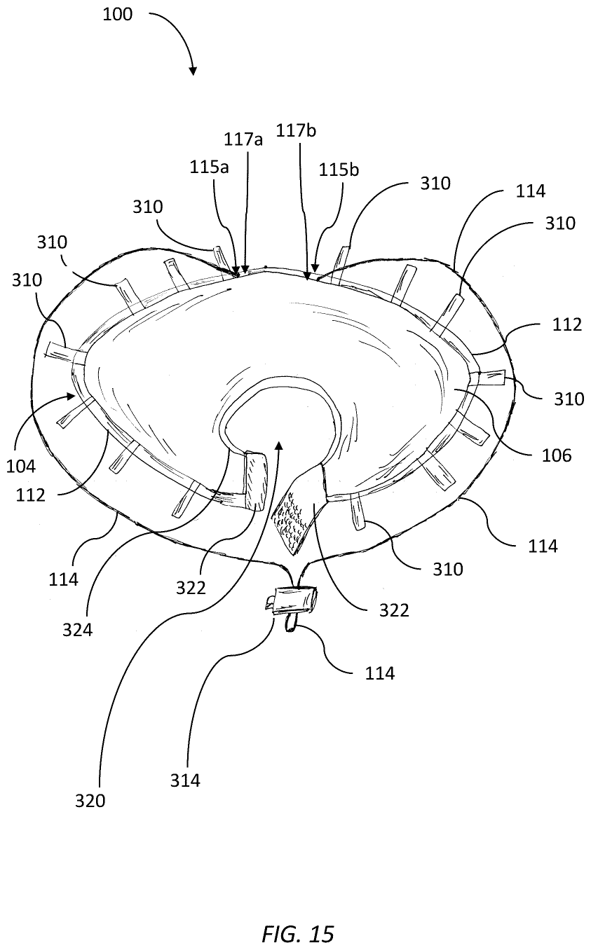

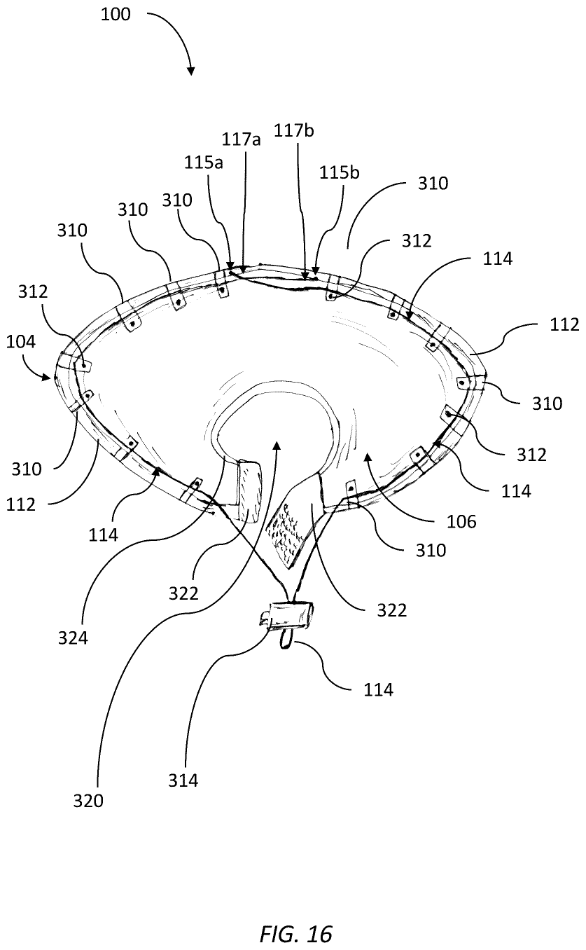

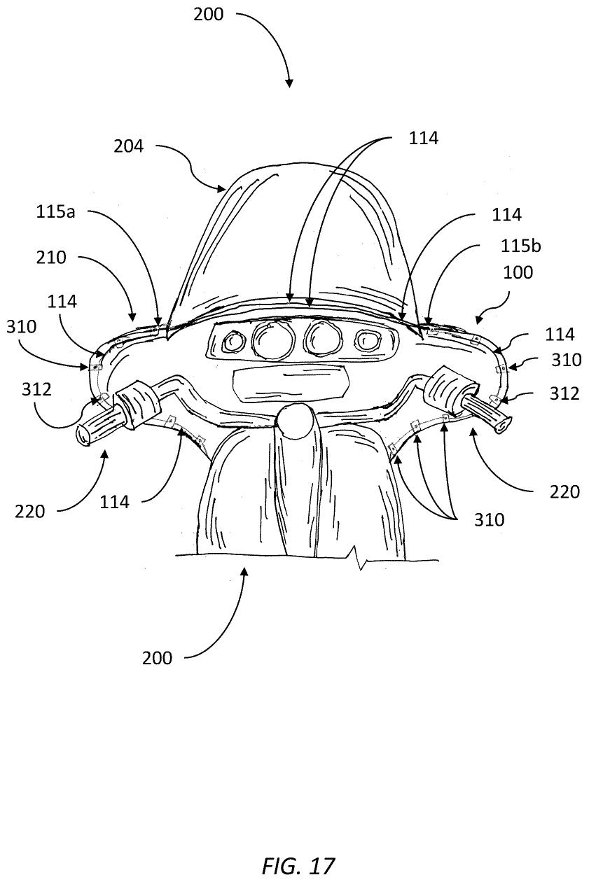

With reference to FIG. 14, FIG. 15, FIG. 16, and FIG. 17, in some aspects of the present disclosure, the cover body 104 does not comprise a body perimeter channel 110. In such aspects of the apparatus 100, the apparatus 100 comprises the perimeter cord 114, and the perimeter cord 114 is affixed to the cover body 104 at the ends of the perimeter cord 114, being referred to as a first perimeter cord end 115a and a second perimeter cord end 115b.

The first perimeter cord end 115a and the second perimeter cord end 115b are, it has been found advantageous, affixed to the cover body 104 at locations approximately near the top of the cover body 104, and may be affixed approximately near where the corners of the windshield 204 of the motorcycle 200 meet the fairing 210. The first perimeter cord end 115a is affixed at a location referred to as a first-cord-end-location 117a, and the second perimeter cord end 115b is affixed at a location referred to as a second-cord-end-location 117b. The perimeter cord 114 is further attached or retained to the cover body 104 with a plurality of cord-retention-units 310, at or in the vicinity of the outer perimeter 112. The plurality of cord-retention-units 310 may be affixed to the outer perimeter or approximately near the outer perimeter of the cover body 104, that is, approximately in the vicinity of the outer perimeter 112, and of plurality of cord-retention-units 310 may be distributed around the outer perimeter 112 of the cover body 104, in a manner or with a distribution which may be approximately even, or may be uneven, as may be advantageous to fit and affix the perimeter cord 114 to the cover body 104 to fit a model of motorcycle 200, or for different models of motorcycles.

The plurality of cord-retention-units 310 may be sewn to the cover body 104, or otherwise affixed to the cover body 104. The plurality of cord-retention-units 310 may each be a single strap having two ends, sewn at both ends of each of the cord-retention-units to the cover body 104. The plurality of cord-retention-units 310 may each be two straps, affixing to the other of each matching pair of said straps by means of a button, or a snap, or a hook-and-loop closure, or other means now known or later invented that are suitable for the functions described herein, wherein the said means of affixing to the other of each matching pair of said straps are referred to as a cord-retention-unit-closure 312, to allow each of the plurality of cord-retention-units 310 to be reversibly opened and closed to hold the perimeter cord 114 inside each of the plurality of cord-retention-units 310. Each or any of the cord-retention-unit-closure 312 may comprise a button, a snap, a hook-and-loop closure, or any other suitable mechanisms of closure now known or later invented, or a combination thereof.

It has been found advantageous to have the perimeter cord 114 cross under the windshield 204 when the apparatus 100 is installed on a motorcycle 200, as is shown in FIG. 16 and FIG. 17, such that the perimeter cord 114 is arranged to be directed from the first-cord-end-location 117a where the first perimeter cord end 115a is affixed, towards the second-cord-end-location 117b, and past that second-cord-end-location 117b where the second perimeter cord end 115b is affixed, with the perimeter cord 114 then passing around the entirety of the outer perimeter 112 of the cover body 104, and to the location where the second perimeter cord end 115b is affixed, at the second-cord-end-location 117b. In such aspects of the apparatus 100, the perimeter cord 114 makes more than a complete circuit around the cover body 104. This has been found advantageous for securing the apparatus 100 to the fairing 210 and keeping the apparatus 100 snug to, meaning relatively near to, the windshield 204 in the approximate vicinity of the fairing 210, and thus securely attached to the motorcycle 200, without posing a distraction or nuisance to the user of the motorcycle 200. The perimeter cord 114 may be secured with a perimeter cord lock 314. The perimeter cord lock 314 may be used to adjust the tension in the perimeter cord 114, thus tightening the perimeter cord 114 around the windshield 204 and the fairing 210. The perimeter cord 114 may be elastic. In some aspects of the present disclosure, the perimeter cord 114 may be non-adjustable.

With further reference to FIG. 1, FIG. 2, FIG. 3, FIG. 4, FIG. 5, FIG. 6, FIG. 7, FIG. 8, and FIG. 9, the cover body 104 further comprises a headlight opening 120. The headlight opening 120 is disposed to fit over and be large enough to accommodate a headlight 206 of a motorcycle 200, or of most motorcycles. The headlight opening 120 is a hole or enlarged slot opening in the cover body 104, and the perimeter of the headlight opening 120 comprises a headlight perimeter channel 122. The headlight perimeter channel 122 is disposed to enclose a headlight perimeter cord 124. The headlight perimeter cord 124 may be elastic, and may be sized and disposed to fit over the headlight 206 of a motorcycle 200, or over a range of the headlights of various motorcycles. In some aspects of the present disclosure, the headlight perimeter cord 124 may be non-adjustable. In some aspects of the present disclosure, the headlight perimeter cord 124 may be adjustable, with the headlight perimeter channel 122 further comprising a headlight perimeter opening 126 through which the headlight perimeter cord 124 extends, and the apparatus 100 comprising a headlight perimeter cord lock 128 to secure and adjust the headlight perimeter cord 124 around the headlight 206.

With reference to FIG. 14, FIG. 15, FIG. 16, and FIG. 17, in some aspects of the present disclosure, the cover body 104 comprises a headlight opening 320, wherein the headlight opening 320 is not a hole in the cover body 104. The headlight opening 320 is disposed to fit over and be large enough to accommodate a headlight 206 of a motorcycle 200, or of most motorcycles. The headlight opening 320 comprises an enlarged slot opening in the cover body 104, with a headlight closure element 322, wherein the headlight closure element 322 may comprise elements on both sides of the cover body 104 adjacent the headlight opening 320, as is shown in FIG. 14, FIG. 15, FIG. 16, and FIG. 17, and wherein the headlight closure element 322 may comprise a hook-and-loop closure, or a button or snap or strap with suitable components, or other mechanisms now known or later invented. The headlight opening 320 may comprise an inner perimeter 324, namely, the edge of the cover body 104 adjacent to the headlight opening 320. There may be disposed around some, most, or all, that is, around at least a portion of the inner perimeter 324, a material that is advantageously at least one of soft, elastic, and/or non-slip, to prevent damage to the paint on and around the headlight 206, and prevent the apparatus 100 from slipping or abrading or otherwise damaging the headlight 206 or the motorcycle 200. A user of the apparatus 100 may place the headlight opening 320 around the headlight 206, and securely fasten the headlight closure element 322 around the headlight 206.

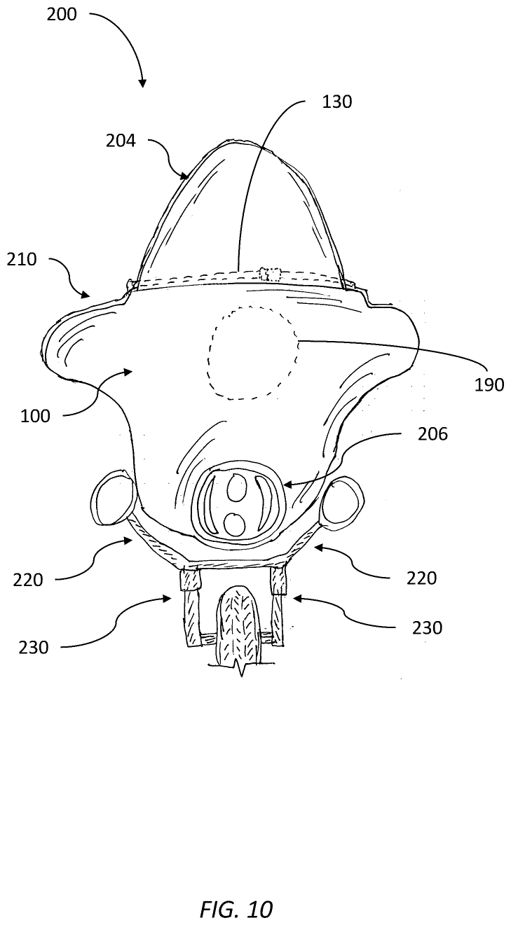

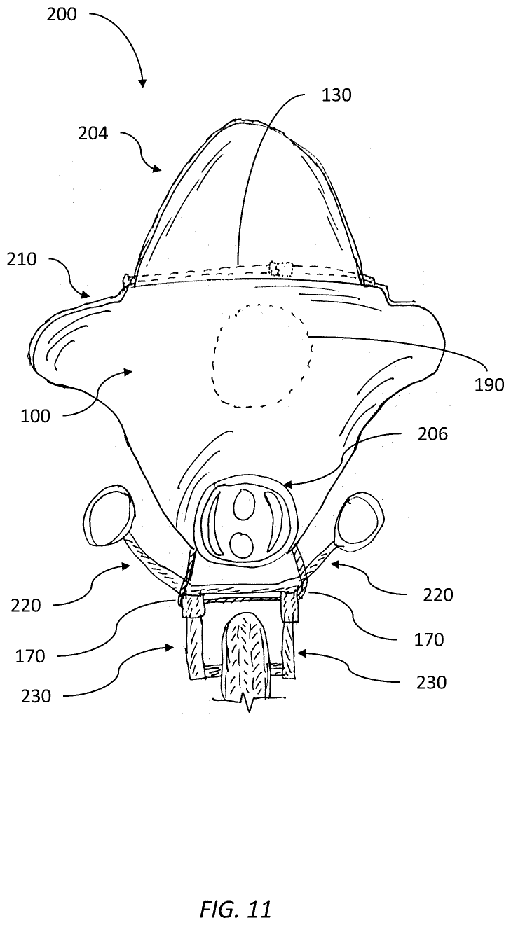

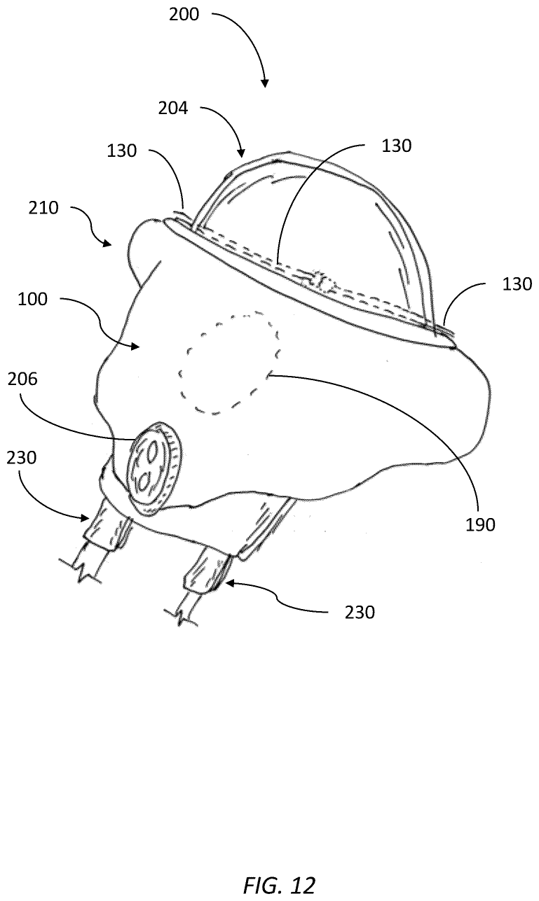

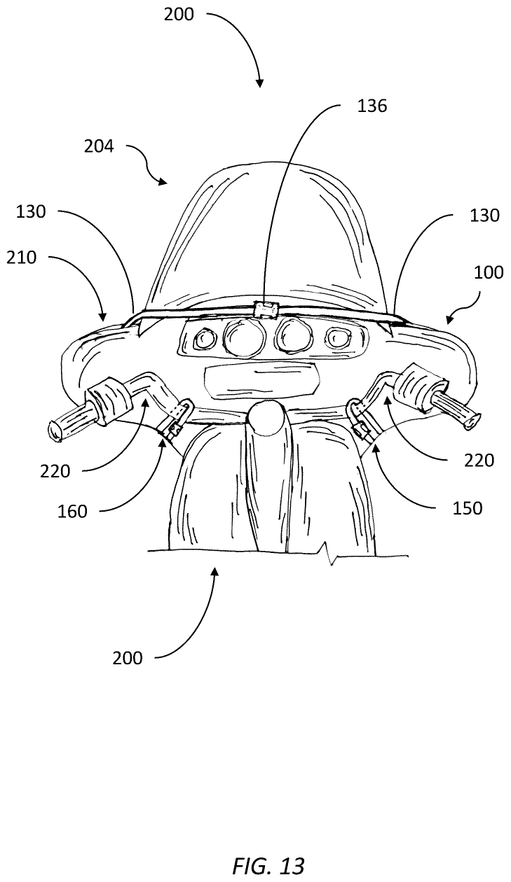

With reference to FIG. 1, FIG. 2, FIG. 3, FIG. 4, FIG. 5, FIG. 7, FIG. 8, FIG. 9, FIG. 10, FIG. 11, FIG. 12, and FIG. 13, the apparatus 100 may further comprise a windshield strap 130. The windshield strap 130 comprises a windshield strap first side 132 and a windshield strap second side 134, and a windshield strap closure 136. The windshield strap 130 may comprise a nylon or other webbing or strap material, or may comprise leather, or other materials now known or later invented, as is known in the art. The windshield strap first side 132 and windshield strap second side 134 may be sewn, glued, or otherwise affixed to the cover body 104 at one or more windshield strap attachment areas 135, wherein the one or more windshield strap attachment areas 135 may be on the back side of the cover body 104 and/or may be at, in, or under the body perimeter channel 110, and/or may be disposed between layers of the body material 106. The windshield strap closure 136 may comprise any one or more types of closures now known or later invented, as is known in the art. Without limiting the foregoing, in some aspects of the present disclosure, the windshield strap closure 136 may comprise a windshield strap first buckle 138a on either the windshield strap first side 132 or the windshield strap second side 134, and a windshield strap second buckle 138b on the other of the windshield strap first side 132 or the windshield strap second side 134, as shown with reference to FIG. 1, FIG. 2, FIG. 3, FIG. 7, FIG. 8, FIG. 9, and FIG. 13. In some aspects of the present disclosure, and with reference to FIG. 4, the windshield strap closure 136 may comprise a windshield strap tri-glide slide 140 disposed on the windshield strap 130, or similar components as is known in the art, to allow a user to lengthen or shorten the windshield strap 130 to accommodate different sizes of motorcycles, windshields, and fairings. In some aspects of the present disclosure, and with reference to FIG. 5, the windshield strap closure 136 may comprise a first windshield strap hook-and-loop region 142a and a second windshield strap hook-and-loop region 142b, which are disposed respectively on the windshield strap first side 132 and the windshield strap second side 134, such that the first windshield strap hook-and-loop region 142a and the second windshield strap hook-and-loop region 142b can be reversibly and repeatedly fastened and opened, to securely hold the windshield strap 130 around the windshield 204, while allowing adjustment of the length of the windshield strap 130.

With reference to FIG. 1, FIG. 2, FIG. 3, FIG. 4, FIG. 5, FIG. 7, FIG. 8, FIG. 9, and FIG. 13, the apparatus 100 may further comprise a right handlebar strap 150, to be fastened around part of the handlebars 220. The right handlebar strap 150 comprises a right handlebar strap first side 152 and a right handlebar strap second side 154, and a right handlebar strap closure 156. The right handlebar strap 150 may comprise a nylon or other webbing or strap material, or may comprise leather, or other materials now known or later invented, as is known in the art. The right handlebar strap first side 152 and the right handlebar strap second side 154 may be sewn, glued, or otherwise affixed to the cover body 104 at one or more right handlebar strap attachment areas 155, wherein the one or more right handlebar strap attachment areas 155 may be on the back side of the cover body 104 and/or may be at, in, or under the body perimeter channel 110, and/or may be disposed between layers of the body material 106. The right handlebar strap closure 156 may comprise any one or more types of closures now known or later invented, as is known in the art. Without limiting the foregoing, in some aspects of the present disclosure, the right handlebar strap closure 156 may comprise a right handlebar strap first buckle 158a on the right handlebar strap first side 152, and a right handlebar strap second buckle 158b on the right handlebar strap second side 154. The right handlebar strap closure 156 can be reversibly and repeatedly fastened around the handlebars 220 on a left side of the motorcycle 200 and opened, to securely hold the right handlebar strap 150 around the handlebars 220, while allowing adjustment of the length of the right handlebar strap 150, to accommodate different sizes of motorcycles, handlebars, and fairings.

With reference to FIG. 1, FIG. 2, FIG. 3, FIG. 4, FIG. 5, FIG. 7, FIG. 8, FIG. 9, and FIG. 13, the apparatus 100 may further comprise a left handlebar strap 160, to be fastened around part of the handlebars 220. The left handlebar strap 160 comprises a left handlebar strap first side 162 and a left handlebar strap second side 164, and a left handlebar strap closure 166. The left handlebar strap 160 may comprise a nylon or other webbing or strap material, or may comprise leather, or other materials now known or later invented, as is known in the art. The left handlebar strap first side 162 and the left handlebar strap second side 164 may be sewn, glued, or otherwise affixed to the cover body 104 at one or more left handlebar strap attachment areas 165, wherein the one or more left handlebar strap attachment areas 165 may be on the back side of the cover body 104 and/or may be at, in, or under the body perimeter channel 110, and/or may be disposed between layers of the body material 106. The left handlebar strap closure 166 may comprise any one or more types of closures now known or later invented, as is known in the art. Without limiting the foregoing, in some aspects of the present disclosure, the left handlebar strap closure 166 may comprise a left handlebar strap first buckle 168a on the left handlebar strap first side 162, and a left handlebar strap second buckle 168b on the left handlebar strap second side 164. The left handlebar strap closure 166 can be reversibly and repeatedly fastened around the handlebars 220 on a right side of the motorcycle 200 and opened, to securely hold the left handlebar strap 160 around the handlebars 220, while allowing adjustment of the length of the left handlebar strap 160, to accommodate different sizes of motorcycles, handlebars, and fairings.

In some aspects of the present disclosure, and with reference to FIG. 14, FIG. 15, FIG. 16, and FIG. 17, the apparatus 100 may comprise no connection to the handlebars 220. Having the apparatus 100 with no connection to the handlebars 220 provides an advantage over other fairing covers, because the apparatus 100 can be used with other models of motorcycles. A motorcycle 200 with a batwing fairing has the fairing move with the handlebars, and other models of motorcycles don't have the handlebars 220 move with the fairing. This aspect of the apparatus 100 attaches only to the fairing 210, and therefore can be used with a motorcycle that has a fairing 210 that turns, and with a motorcycle that has a fairing 210 that is static.

With reference to FIG. 3, FIG. 4, FIG. 5, FIG. 6, FIG. 9, FIG. 10, FIG. 11, FIG. 12, and FIG. 13, the apparatus 100 may further comprise a forks strap 170, to be fastened around part of the forks 230. The forks strap 170 may serve to further secure the apparatus 100 to the motorcycle 200, across a range of sizes of motorcycles, fairings, and forks. The forks strap 170 comprises a forks strap first side 172 and a forks strap second side 174, and a forks strap closure 176. The forks strap 170 may comprise a nylon or other webbing or strap material, or may comprise leather, or other materials now known or later invented, as is known in the art. The forks strap first side 172 and the forks strap second side 174 may be sewn, glued, or otherwise affixed to the cover body 104 at one or more forks strap attachment areas 175, wherein the one or more forks strap attachment areas 175 may be on the back side of the cover body 104 and/or may be at, in, or under the body perimeter channel 110, and/or may be disposed between layers of the body material 106. The forks strap closure 176 may comprise any one or more types of closures now known or later invented, as is known in the art. Without limiting the foregoing, in some aspects of the present disclosure, the forks strap closure 176 may comprise a forks strap first buckle 178a on the forks strap first side 172, and a forks strap second buckle 178b on the forks strap second side 174. The forks strap closure 176 can be reversibly and repeatedly fastened around the forks 230 or aspects of the forks 230, and opened, to securely hold the forks strap 170 around the forks 230, while allowing adjustment of the length of the forks strap 170, to accommodate different sizes of motorcycles, forks, and fairings.

In some aspects of the present disclosure, and with reference to FIG. 6, the apparatus 100 may comprise a windshield opening 180. The windshield opening 180 may be disposed in the cover body 104, approximately near to an upper edge or portion of the cover body 104. While the depiction in FIG. 6 presents the windshield opening 180 and not the windshield strap 130, in some aspects of the present disclosure it is possible to present both the windshield opening 180 and the windshield strap 130. In aspects of the apparatus 100 comprising the windshield opening 180, the windshield opening 180 may serve to securely hold the apparatus 100 around the windshield 204. The windshield opening 180 comprises an opening in the cover body 104, suitably sized and disposed to accommodate the windshield 204 of any of a range of motorcycles, by being slid around and down over the windshield 204, as will be apparent to one of skill in the art. The windshield opening 180 further comprises a windshield perimeter channel 182, disposed around an inner perimeter 181 of the cover body 104. The windshield perimeter channel 182 is advantageously affixed shut by an amount of the body material 106, and encloses a channel disposed to contain a windshield perimeter cord 184, and wherein the windshield perimeter cord 184 extends around the inner perimeter 181 of the cover body 104. The windshield perimeter channel 182 comprises, advantageously, a windshield perimeter opening 186. The windshield perimeter cord 184 extends through the windshield perimeter opening 186. The windshield perimeter cord 184 may be secured with a windshield perimeter cord lock 188. The windshield perimeter cord lock 188 may be used to adjust the tension in the windshield perimeter cord 184, thus tightening the windshield opening 180 around the windshield 204. The windshield perimeter cord 184 may be elastic, and may be sized and disposed to fit over the windshield 204 of a motorcycle 200, or over a range of the windshields of various motorcycles. In some aspects of the present disclosure, the windshield perimeter cord 184 may be non-adjustable.

Certain aspects of the present invention were described above. From the foregoing it will be seen that this invention is one well adapted to attain all the ends and objects set forth above, together with other advantages, which are obvious in and inherent to the inventive apparatus disclosed herein. It will be understood that certain features and sub-combinations are of utility and may be employed without reference to other features and sub-combinations. It is expressly noted that the present invention is not limited to those aspects described above, but rather the intention is that additions and modifications to what was expressly described herein are also included within the scope of the invention. Moreover, it is to be understood that the features of the various aspects described herein are not mutually exclusive and can exist in various combinations and permutations, even if such combinations or permutations were not made express herein, without departing from the spirit and scope of the invention. In fact, variations, modifications, and other implementations of what was described herein will occur to those of ordinary skill in the art without departing from the spirit and the scope of the invention. As such, the invention is not to be defined only by the preceding illustrative description.

Accordingly, what is claimed is:

1. An apparatus for a motorcycle fairing cover, the apparatus comprising:
a cover body, which cover body comprises a body material and a perimeter cord, and wherein the perimeter cord extends around an outer perimeter of the cover body;
and wherein the perimeter cord is affixed to the cover body at a location on the cover body referred to as a first-cord-end-location, at a first perimeter cord end of the perimeter cord,
and wherein the perimeter cord is affixed to the cover body at a location on the cover body referred to as a second-cord-end-location, at a second perimeter cord end of the perimeter cord;
and wherein the perimeter cord is further retained to the cover body with a plurality of cord-retention-units, in a vicinity of the outer perimeter.

2. The apparatus of claim 1, wherein the first perimeter cord end and the second perimeter cord end are affixed to the cover body at locations approximately near a top of the cover body.

3. The apparatus of claim 1, wherein the first perimeter cord end and the second perimeter cord end are affixed to the cover body at locations approximately near where the corners of a windshield of a motorcycle meet the motorcycle fairing cover of the motorcycle.

4. The apparatus of claim 1, wherein the perimeter cord may be secured with a perimeter cord lock.

5. The apparatus of claim 1, wherein the plurality of cord-retention-units are affixed to the outer perimeter of the cover body, and wherein the plurality of cord-retention-units are distributed around the outer perimeter of the cover body.

6. The apparatus of claim 1, wherein the plurality of cord-retention-units are affixed approximately near the outer perimeter of the cover body, and wherein the plurality of cord-retention-units are distributed around the outer perimeter of the cover body.

7. The apparatus of claim 1, wherein the plurality of cord-retention-units are each a single strap having two ends, sewn at both ends of each of the plurality of cord-retention-units to the cover body.

8. The apparatus of claim 1, wherein the plurality of cord-retention-units are each two straps, affixing to the other of each matching pair of said straps by a cord-retention-unit-closure, wherein each of the plurality of cord-retention-units comprise a cord-retention-unit-closure.

9. The apparatus of claim 1, wherein the perimeter cord crosses under a windshield of a motorcycle when the apparatus is installed on the motorcycle, wherein the perimeter cord is directed from the first perimeter cord end at the first-cord-end-location, towards the second-cord-end-location, and past the second-cord-end-location, and wherein the perimeter cord is directed from the second perimeter cord end at the second-cord-end-location, towards the first-cord-end-location, and past the first-cord-end-location.

10. The apparatus of claim 1, wherein the cover body comprises a headlight opening, wherein the headlight opening is not a hole in the cover body; and
wherein the headlight opening comprises an enlarged slot opening in the cover body; and wherein the cover body further comprises a headlight closure element; wherein the headlight closure element comprises elements on both sides of the cover body adjacent the headlight opening.

11. The apparatus of claim 10, wherein the headlight opening comprises an inner perimeter; and wherein there is disposed around at least a portion of the inner perimeter a material that is at least one of soft, elastic, and/or non-slip.

12. The apparatus of claim 1, wherein the apparatus comprises no connection to the handlebars of a motorcycle.
